(19) United States
(12) Patent Application Publication
(10) Pub. No.: US 2010/0147606 A1
(43) Pub. Date: Jun. 17, 2010

(54) ELECTRIC VEHICLE WITH INCREASED RANGE

(75) Inventors: Markus Kalenborn, Wuerselen (DE); Christof Tiemann, Koln (DE); Christoph Bollig, Aachen (DE)

Correspondence Address: GIFFORD, KRASS, SPRINKLE,ANDERSON & CITKOWSKI, P.C, PO BOX 7021, TROY, MI, 48007-7021, US

(73) Assignee: FEV MOTORENTECHNIK GMBH, Aachen (DE)

(21) Appl. No.: 12/372,779

(22) Filed: Feb. 18, 2009

(30) Foreign Application Priority Data
Dec. 11, 2008 (DE) DE102008061295.5

(51) Int. Cl. B60K 6/20; B60W 10/04; B60W 20/00

(52) U.S. Cl. 180/65.21; 180/65.265; 180/65.275

(57) ABSTRACT

The present invention relates to a drive mechanism of an electric vehicle that is realized only by means of one or more electric motors that are connected to at least one storage battery, wherein a generator is provided that can be connected for supplying energy to the drive mechanism, wherein the generator is coupled to a Wankel engine that drives only the generator when needed, but delivers no driving power as torque to the drive train of the electric motor or motors of the drive mechanism. A method for operating an electric vehicle is also presented.

### CROSS-REFERENCE TO RELATED APPLICATIONS

This application claims priority of German patent application DE 10 2008 061 295.2 filed Dec. 11, 2008.

### FIELD OF THE INVENTION

The present invention relates to a drive mechanism of an electric vehicle that is driven only by means of one or more electric motors.

### BACKGROUND OF THE INVENTION

In various countries, legal regulations require that vehicle fleets must also include electric vehicles, in order to be able to achieve exhaust-gas targets. The advantage of electric vehicles is that no exhaust gases are produced when they are used. Instead, the exhaust gases are generated when the power is generated and thus do not fall within the scope of exhaust-gas emissions of vehicle fleets. In addition, for such energy production, the energy generator is typically operated in an operating range with no load steps, or only very rarely with load steps, and thus the operating range does not change or changes only very rarely. This realizes an especially energy-efficient, and resource-conserving conversion of fuels if the electrical energy has not been obtained through renewable energy sources.

A disadvantage in electric vehicles is essentially the limitation of range. The range is often limited by the storage capacity of the batteries. The greater the range that is demanded, the greater the space required for rechargeable batteries.

The objective of the present invention is to increase the range of an electric vehicle without having to enlarge the necessary storage batteries.

### SUMMARY OF THE INVENTION

This objective is accomplished with a drive mechanism with the features of Claim 1 and also with a method with the features of Claim 21. Additional advantageous configurations and improvements are specified in the respective subordinate claims, wherein the features contained there are not limited to the individual configuration according to the subordinate claim, but instead can be combined with other features from the description or from the claims to form improvements.

A drive mechanism of an electric vehicle is proposed that is realized only by means of one or more electric motors, wherein the electric motor or motors are connected to at least one storage battery. A generator is provided that can be connected for supplying energy to the drive mechanism. The generator is coupled to a Wankel engine that drives only the generator when needed, but provides no driving power as torque to a drive train of the electric motor or motors of the drive mechanism.

The Wankel engine is therefore connected to the generator in a way that allows only the generation of electric energy, but does not generate a torque that would be able to be transferred to the driven wheels of the electric vehicle. A connection between the generator and the Wankel engine is advantageously designed so that the generator has a rotor shaft that is coupled to a driven shaft of the rotary piston engine. The driven torque of the rotary piston engine is not transferred via the generator. One configuration here provides that a gearbox is arranged between the generator and the Wankel engine. Thus, it can be that, for example, a rotor shaft of the generator is coupled on both sides to a drive shaft. By means of the coupling, the Wankel engine can be coupled to the generator on one side. In contrast, on the other side of the rotor shaft, for example, the drive train for the electric motor or motors can be coupled.

By means of a gearbox and/or a clutch there first of all is the ability for the Wankel engine to generate an adapted rotational speed ratio for the power production in the generator. Second, by means of a clutch for example, the connection between the generator and the Wankel engine can be broken. This is useful, for example, in those cases in which the generator is driven by the drive train of the electric motors. In this case, the generator is used, for example, as a brake, in which case energy is also generated during the braking. In addition there is the possibility that a free-running hub is provided between the generator and the Wankel engine. In this way, for example, a coupling to the drive train of the electric motors can also be provided, wherein, in this way, a reversal of rotational direction does not feed back to the Wankel engine. Additional advantages result from the arrangement of a gearbox or a clutch between the generator and the Wankel engine. In this way, for example, the Wankel engine can reach a minimum rotational speed before the generator is coupled and thus driven. There is also the possibility to allow not only an increase in rotational speed but also a decrease by means of the connection setup between the gearbox and the clutch. For example, the gearbox with associated control unit can automatically select the gear ratio that has proven to be favorable due to settings, for example, of a control device, based on the applied load demand for the generator. The gearbox can also be an automatic gearbox by means of which a gear ratio from the Wankel engine to the generator can be changed continuously.

Another configuration provides for a disk flywheel to be associated with the Wankel engine. The disk flywheel is preferably arranged between the generator and the Wankel engine. Advantageously, the arrangement is such that coupling and decoupling between the Wankel engine and the disk flywheel is enabled. The clutch, for example, can be used for this purpose. One possible application is given for the startup of the Wankel engine. For example, the generator can drive the disk flywheel. At this point in time, the Wankel engine is separated from the disk flywheel and its torque. Through, for example, a coupling process, a force-transmitting or torque-transmitting connection can be realized between the disk flywheel and the Wankel engine, and in this way the Wankel engine can be started. Such a process can be realized, for example, by means of a control device. For example, this control device can provide that, in particular, when a given torque or rotational speed is reached, the Wankel engine is connected and a torque is transmitted to this engine. Such a startup is preferred, for example, when a charge state of the storage battery does not permit a startup by means of, for example, a starter motor. Therefore, such a startup of the Wankel engine can be provided as an alternative startup option for the drive mechanism. According to one configuration, the flywheel is gradually rotated faster and faster. This is possible, in particular, also for a charge state of the storage battery that would not be sufficient for another startup possibility. In particular, there is the possibility of realizing a different startup process, adapted to a charge state of the storage battery, for example, by the generator increasing the rotation of the disk flywheel at different rates and also, according to one improvement, by an additional selection with respect to an additional starter motor that can be used. It can also be provided that the Wankel engine is started only by means of torque transmission from the disk flywheel to the Wankel engine.

In particular, for preventing fluctuations of tie electrical energy generated by the generator, it can be provided that the Wankel engine is operated at a preferably fixed operating point or within an operating range, independent of which load demand of the instantaneous operation is placed on the electric motors of the electric vehicle. In this way it can be guaranteed that the Wankel engine is operated in an operating range that allows the best possible fuel conversion with the smallest possible emissions. The Wankel engine can be used, in particular, as a quasi-stationary engine for driving the generator. For this purpose, a control device advantageously provides, as normal operation, that the operating range of the Wankel engine comprises, to the extent possible, no more than 200 revolutions/min bandwidth of changing revolution speeds despite the load of the generator. In addition to a normal operation in which the Wankel engine drives tie generator such that this charges the storage battery or batteries, it can also be provided that the generator generates an electrical current that is fed directly to the one or more electric motors For this purpose, it can be provided that by means of the gearbox or a clutch, a change in rotational speed is adapted to the voltage or to the current to be generated by the generator. However, it can also be provided that, for this purpose, a corresponding electric circuit is provided downstream of the generator to ensure that the required current or tie required voltage is applied to the electric motor. There is also the possibility of combining these two.

Another configuration provides, for example, that the Wankel engine is used for the startup of the electric vehicle, wherein the Wankel engine generates the electrical energy via the generator, so that the electric vehicle can be driven by means of the electric motors or the electric motor. Such a situation can occur, for example, in case of a disruption or a loss of the storage battery or batteries or when the voltage that is generated by the storage batteries or the storage battery is too small. In addition, there is the possibility that the Wankel engine generates additional electrical energy at the required point in time via the generator. This can be required, for example, during acceleration processes in which not enough energy can be supplied via the storage battery. There is also the possibility that the Wankel engine generates the required voltage by means of the generator when the voltage supply via the storage battery itself is too low for the operation of the electric vehicle. In this way, the range of the electric vehicle can be expanded without having to recharge the storage battery or batteries. In particular, the arrangement of the generator and Wankel engine is therefore suitable for allowing an improvement in the range of the electric vehicle so that it is guaranteed that storage batteries can be recharged by reaching the next recharging station.

According to one improvement it is provided that a connection between the generator and the Wankel engine and also the generator and the Wankel engine themselves are mounted on a common frame. Advantageously, the frame is arranged on the electric vehicle in this way so that it is replaceable. For example, the frame can be pushed into an opening provided for this purpose, wherein coupling to the other systems of the electric vehicle can be realized, for example, at least partially automatically. Thus, for example, it can be provided that when the frame is installed, pushed in, or inserted, corresponding electrical contacts can be closed that allow the current generated by the generator to be forwarded electrically to the storage battery or batteries or the electric motors. In this way, a bus connection can also be closed, so that a connection for a control device advantageously also housed on the frame to a higher-level control device of the electric vehicle is guaranteed. One or more such electrical contacts can engage, for example, in one or more other electrical counter contacts when the frame is pushed in and thus can establish a connection. In addition, there is the possibility, alternatively and additionally, to be able to establish such a connection between the components involved by means of suitable plug contacts. Another configuration provides that a fuel tank for the Wankel engine is arranged on the frame itself. This allows, for example, for the Wankel engine to be filled up from the outside, before the frame with the Wankel engine and generator is inserted. On the other hand, this also allows installation or disassembly together with the frame, without lines carrying fuel having to be disconnected or reassembled. This increases the operational safety of such a drive module composed of a generator and Wankel engine.

Another configuration provides that the generator and the Wankel engine are arranged on the common frame so that the housing of the Wankel engine, in alignment viewed laterally, does not project past a housing of the generator. In this way it is possible to generate an extremely compact module that presents a corresponding simplification, particularly with respect to the installation and disassembly. A further improvement results, for example, if there is an exhaust-gas treatment device for the Wankel engine that is fixed to a frame for the generator and Wankel engine. The module formed in this way allows, for example, the entire exhaust-gas line to be examined when the module comprising the generator, Wankel engine, and exhaust-gas treatment device, in addition to the frame, has been removed from the electric motor. Advantageously, an entire exhaust-gas train is arranged on the frame. Another configuration provides that at least one muffler of an exhaust gas train of the Wankel engine is arranged on the frame.

One preferred configuration provides that, for example, a radiator, a fan, the Wankel engine, the generator, and then a muffler are arranged one after the other on a frame, wherein an exhaust-gas post-treatment device is arranged underneath or on the side of the aforementioned assemblies on the frame. Advantageously, thermal insulation is provided between the exhaust-gas line, in particular, the exhaust-gas post-treatment device and the next components, in particular, the Wankel engine or the generator. One arrangement of the exhaust-gas post-treatment device underneath the frame allows for the frame itself to be arranged in the electric vehicle so that the exhaust-gas post-treatment device then points toward the road surface. This prevents the exhaust-gas post-treatment device and, in particular, also the exhaust-gas line from running somewhat in the interior of the electric vehicle and thus possibly leading to problems with overheating in this area. If it is to be provided to allow the exhaust-gas line to run at least partially in the electric vehicle, corresponding thermal insulation is provided at least for these regions.

The arrangement of a module having a generator and a Wankel engine, preferably on an installable frame, also allows specific components of a drive mechanism of an electric vehicle to be installed at different positions of the motor vehicle. Thus, according to one configuration it can be provided, for example, that the generator and the Wankel engine are arranged at one end of the vehicle and one or more electric motors are arranged at the opposite end of the vehicle. For example, it can be provided that an electric motor is arranged on each driving wheel of a single driven axle. The generator and also the Wankel engine are arranged in the region of the other axle of the motor vehicle, in this way, for example, a uniform distribution of weight can be achieved across the electric vehicle.

In addition, there is the possibility of connecting the Wankel engine to a fuel system arranged in the electric vehicle. Thus, for example, the electric vehicle can have a fuel cell that can be operated, in turn, with corresponding fuel, in particular, hydrogen. However, there is also the possibility of operating the fuel cell, for example, with methanol, ethanol, or other hydrocarbons from which the hydrogen is obtained through catalytic processes shortly before use. The use of natural gas for operating the fuel cell is also possible, in which case the Wankel engine would then also advantageously operate with natural gas. In addition, there is the possibility of being able to operate the Wankel engine with diesel fuel, biofuel, and also normal gasoline. The Wankel engine is advantageously sound-encapsulated. Such encapsulation can surround, for example, the frame on which the generator and the Wankel engine are arranged. Fuel provision for the Wankel engine can then be realized advantageously outside of this encapsulation. It is preferred that a fuel tank for the Wankel engine is arranged in its immediate vicinity. In this way it is unnecessary to provide long lines for carrying the fuel in the electric vehicle. In particular, it is preferred to arrange the fuel tank on the frame on winch the Wankel engine is also arranged. In this way a coupling point can be eliminated that otherwise would have to be detached or connected if the frame and the Wankel engine were to be disassembled from the electric vehicle.

It is further preferred if the Wankel engine has its own cooling system. This can be, for example, independent of a cooling system of the electric vehicle. Advantageously, this cooling system is arranged completely on the frame. Thus, liquid cooling can be provided, according to one configuration, wherein water or oil is used as the cooling liquid. In particular, oil can be used that is also used in a lubricating circuit. One improvement provides that the Wankel engine features, additionally or only, air cooling. For this purpose, an air cooler that can be driven by the Wankel engine itself by means of a corresponding drive shaft or a corresponding connection to the driven shaft of the Wankel engine for example, is allocated to the Wankel engine. However, there is also the possibility of electrically driving the air cooler in the form of a fan. The necessary electrical voltage can be fed, for example, from a storage battery of the electric vehicle. Another configuration provides that the electrical energy is made available by the generator. For cooling, another configuration provides that for cooling Wankel engine, an electrical energy storage device, from which the necessary current is drawn for activating the fan after the Wankel engine is turned off, is also provided on the frame. This electrical current storage device can also be, for example, a correspondingly dimensioned capacitor.

The electric vehicle advantageously has a storage battery that is a lithium-ion storage battery. The storage battery is advantageously constructed lice that from DE 10 2007 009 009, which is incorporated in full by reference into this disclosure. Another possible configuration of a lithium-ion battery emerges from that with the filing number PCT/EP 2008/008459 with the title “Lithium-ion battery,” which is also incorporated in full by reference into the scope of this disclosure. Another possibility of ensuring an energy supply is possible, for example, with a modular battery, as emerges, for example, from DE 10 2006 043 831. This application is also incorporated by reference in fall into the scope of this disclosure in this respect.

One improvement provides power monitoring for monitoring an operating state of the storage battery by means of which the Wankel engine is activated. The power monitoring can recognize, for example, a voltage state of the storage battery with time precision, but in particular, also in advance. If a given parameter is reached, then the power monitoring can ensure that the Wankel engine generates additional energy that is converted into electrical energy by the generator and is then made available to the storage battery and/or an electric motor of the electric vehicle. The power monitoring can be provided, for example, directly on the generator or also on the storage battery. However, it can also be included in a control device of the electric vehicle for controlling the electric motors. It can also be provided that a control device is allocated, for example, to one or more storage batteries, wherein this control device ensures that a sufficient electrical voltage or a sufficient electrical current is made available, while another control device ensures that a power demand from the driver is appropriately met. Here, the control device can use, for example, the generator and thus also the Wankel engine for generating the necessary electrical energy for the electric motors but also a controller or regulator of the electric motors or the individual electric motors.

In addition, there is the possibility of coupling the Wankel engine to a heating device. The heating device can receive heat from the Wankel engine and can convey it to components to be heated. The heat dissipation can be realized either directly from the Wankel engine or from an exhaust-gas flow or a component of the exhaust-gas line. In this way, for example, an interior of the electric vehicle can be heated. Especially at temperatures that are near or below the zero point in degrees Celsius, it can be advantageous, for example, to also start the Wankel engine is for starting the electric vehicle. This can deliver enough energy via the generator, for example, to activate electrical loads for heating an interior of the electric vehicle, without there being too high a power demand compared with that of the storage battery alone. In addition there is the possibility of using the exhaust heat itself for heating the interior of the electric vehicle. For example, exhaust heat of the Wankel engine can be used here in that it has a ventilation system that draws and guides the exhaust-heat air so that this heated air can be guided into the interior of the electric vehicle. A corresponding ventilation system can be provided, which can also be interrupted advantageously by means of, for example, a flap. In this way, different heating systems can be coupled with each other, for example, electrical heating with air heated by engine exhaust heat. For example, it can be provided that the current temperature that is made available at least, for example, for using the heat of the Wankel engine, is detected by means of a temperature sensor. If this temperature is sufficient, so that requested heating is possible just from this exhaust heat, then, for example, electrical heating can be left out.

Another component that can be heated via the engine exhaust heat, for example, is the storage battery. Here, heating can be performed, for one, by means of electrical current but also by means of engine exhaust heat. In particular, at temperatures very far below 0° C. it is necessary to prevent the storage battery from freezing during standstill times. The same applies to any coolant or lubricant. While it is known that a piston engine can be prevented from freezing, for example, in Nordic countries by means of corresponding electrical heating, such electrical heating can also be provided for the Wankel engine, for example, by means of the storage battery, if no other power network is available. However, there is also the possibility that the Wankel engine itself heats a thermal storage battery sufficiently to have sufficient thermal energy for reliably supplying heat to components to be heated. For this purpose, for example, a salt-based thermal storage battery can be used. In addition, there is the possibility that the Wankel engine is used for parking heating, wherein the storage battery can be charged simultaneously. For example, by means of a control device it can be provided that during a standstill time, the Wankel engine is automatically started in a controlled way, a preset quantity of heat, for example, and/or a quantity of current can be generated, and then this engine can be automatically turned off again. Such a process can be performed, for example, under conditions of extreme cold or because the energy state of the storage batteries is too low.

Incidentally, “Wankel engine” is understood here to mean wherein a rotary piston Wankel engine and also a planetary piston Wankel engine can be used.

According to another concept of the invention, a method is proposed for operating an electric vehicle that is driven only by means of one or more electric motors, wherein a storage battery operating state is monitored and when a preset parameter is reached, a Wankel engine is activated, wherein the Wankel engine drives only a generator in the electric vehicle, by means of which the electrical energy is generated that is used for driving the electric vehicle. This procedure can apply the configurations discussed above individually, in order to be able to use special advantages of this operation of the Wankel engine.

### BRIEF DESCRIPTION OF THE DRAWINGS

The following drawings show, using an example configuration, additional features of the invention, with no configuration of the individual figures to be interpreted as limiting. Also, the features emerging from the individual figures are not limited to the individual configurations. Instead, one or more of these features can be linked with other features from other figures, as well as from the above description concerning improvements. Shown are:

FIG. 1, in schematic view, an electric vehicle with a proposed module comprising a Wankel engine coupled with a generator,

FIG. 2, a schematic view of a possible configuration of a Wankel engine and generator and other components on a frame,

FIG. 3, a possible arrangement of different components in an electric vehicle as an example, and

FIG. 4, a schematic diagram of an example coupling of a Wankel engine, generator, and disk flywheel arranged in between.

### DETAILED DESCRIPTION OF THE PREFERRED EMBODIMENTS

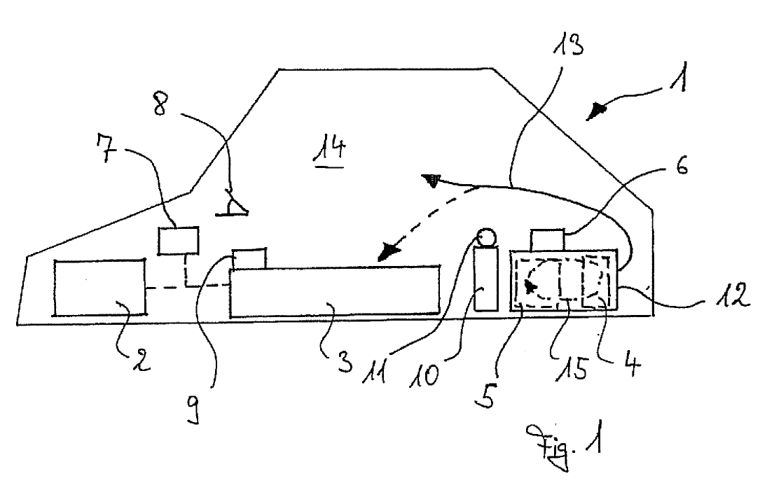

In an exemplary configuration and schematic view, FIG. 1 shows an electric vehicle 1. The electric vehicle 1 has at least one electric motor 2, at least one storage battery 3, and also a generator 4 and a Wankel engine 5, shown with dashed lines and arranged as a composite component in the electric vehicle 1. With each associated drive axle, the electric motor or motors 2 form the drive train of the electric vehicle 1. In principle, however, the generator 4 with the Wankel engine 5 is a standalone energy generator with which electrical current can be generated for the storage battery 3. The generator 4 and the Wankel engine 5 are advantageously arranged here on a common frame. For example, a control unit 6 can also be provided at or on the frame. The control unit 6 is, for example, a control device that is in contact via a bus system with a higher-level, second control device 7. The higher-level, second control device is capable, in particular, of operating the electric motor 2 with respect to a driver's demand transmitted, for example, by means of a pedal system 8. For this purpose, the higher-level second control device 7 can also access a third control device 9. The third control device 9 is responsible, for example, only for one or more storage batteries 3. For example, this can equalize one or more storage batteries relative to each other, can detect their operating states, can detect error reports from individual units of the storage batteries, and can also provide other functions like those known, for example, from the state of the art mentioned above. In this respect, the publications above are incorporated in full by reference.

The Wankel engine 5 can be connected, for example, to a fuel tank 10 arranged in the electric vehicle 1. The fuel tank 10 can have a tank nozzle 11, so that the Wankel engine 5 can be supplied with typical fuel at a gas station. The fuel tan 10, however, can also be arranged on the frame on which the generator 4 and the Wankel engine 5 are also arranged. In such a case, this component forms a standalone current generator unit that can also be operated outside of the electric vehicle 1. This can be useful, for example, if an installation or disassembly of these components is possible without additional means and therefore a current generator is also enabled for other purposes. The voltage that can be generated by the generator 4 can be transformed, for example, to 24 volts, 42 volts, and also 220 volts. Also, different voltages on the side of this component consisting of the generator 4 and Wankel engine 5 can be generated, for example, at different terminals. Thus, in the electric vehicle 1, for example, a part of the onboard network can also be operated directly by means of the generator 4. Here it is preferred that appropriate elements be provided to adequately guarantee uniformity of the current and the voltage.

The components housed together on the frame, such as the Wankel engine 5 and the generator 4, can also be, in particular, encapsulated. Encapsulation 12 allows for special sound damping. For example, the Wankel engine 5 and the generator 4 are set on corresponding vibration dampers, so that an only very slight uneven running in a Wankel engine can be almost completely damped with optional, additional equalization weights. Noise encapsulation prevents the interior of the electric vehicle 1 from being subjected to the operation of the Wankel engine 5. In addition, the encapsulation 12 can also be used such that a dissipation of heat from the Wankel engine 5 and exhaust gas components can be realized in a targeted manner. Thus, for example, it is shown in FIG. 1 that an exhaust gas flow 13 can heat, for example, an interior 14 of the electric vehicle 1 and/or a storage battery 3. For example, circuit cooling 15, shown with dashed-dotted lines is provided for the Wankel engines. The circuit cooling 15 is arranged according to the shown variant within the encapsulation. It can carry fluid. For example, exhaust heat can be provided via an exhaust-heat coupling, for example, in the form of a heat exchanger, to another circuit that runs in the electric vehicle 1 and along which the exhaust heat can be distributed as exhaust heat flow 13, as shown. Preferably, the circuit cooling 15 is liquid cooling. Here, water but also oil can be used, particularly an oil with which rotating components of the Wankel engine 5 can be lubricated.

Preferably, for the electric vehicle 1 an individual electric motor is provided, for example, as a permanent magnet synchronous motor with an output of 35-65 kilowatts. Preferably, a storage battery system consisting of a lithium-ion system is used as the storage battery that preferably delivers more than 10 kilowatt-hours, preferably more than 12 kilowatt-hours. The Wankel engine advantageously has a design interacting with the generator such that at least 20 kilowatts of additional output can be used. The lithium-ion storage battery advantageously has 40 Ah cells, wherein the electric motor can be used with a peak output in the amount of advantageously at least 65 kilowatts, preferably of 75 kilowatts and more. This enables the vehicle, in particular in use as a city vehicle, to be able to accelerate quickly without any problem and to be able to be used at speeds prevalent in the city and also in the environs around the city without any problem. Preferably, in interaction of the electric motor 2 and storage battery 3, the electric vehicle has a range of at least 100 km. Through the additional use of the Wankel engine 5 and generator 4, this range can be extended to at least 300 km. This is measured with a filly charged storage battery and also completely filled tank for the Wankel engine. Preferably, the electric vehicle 1 is capable of accelerating from 0-100 km/h in under 10 seconds. An ultimate speed of the electric vehicle 1 is advantageously above 120 km/h, so that even the recommended legal speed on German expressways is ensured for short trips on these highways.

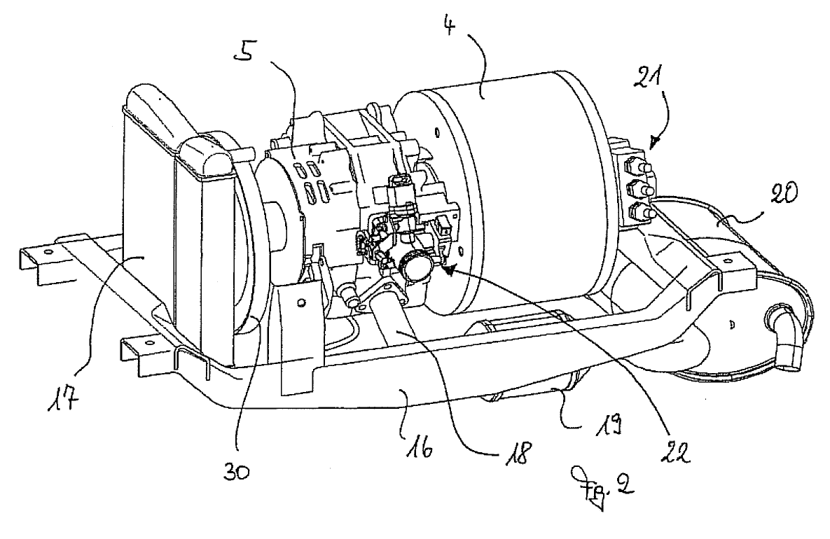

In a schematic diagram, FIG. 2 shows an example of a setup of a composite component consisting of a generator 4 and a Wankel engine 5 that are arranged on a frame 16. The frame 16 has a frame structure on which there are also, advantageously, add-on parts for the components that are connected to each other, the generator 4 and Wankel engine 5. In this setup, the Wankel engine 5 also has a fan 30 along its rotational axis. It is advantageously driven directly by means of a shaft of the Wankel engine 5. In addition, a radiator 17 is arranged in front of the fan 16 on the frame 16. The radiator 17 can comprise either a closed cooling circuit that is arranged on the frame 16, or the radiator 17 can also be integrated in a cooling system that is provided in the electric vehicle itself. Advantageously, an exhaust gas line 18 that can also be arranged on the frame 16 is provided. The exhaust gas line 18 has, for example, an exhaust gas treatment device 19 in the form of, for example, a particulate filter, an NOx trap, a catalytic converter, or a component fulfilling various tasks. As mentioned, a muffler can also be arranged on the frame 16 downstream of the exhaust gas treatment device 19. The generator 4 has, in turn, a terminal field 21 that enables a connection to the power network of the electric vehicle. Another add-on component is, for example, a fuel supply 22 that can be brought into connection, for example, with a fuel tank. The frame 16 advantageously has U-profiles that can be used for a positively-fit connection. In addition there are boreholes so that the frame can also be mounted in the electric vehicle with a screw.

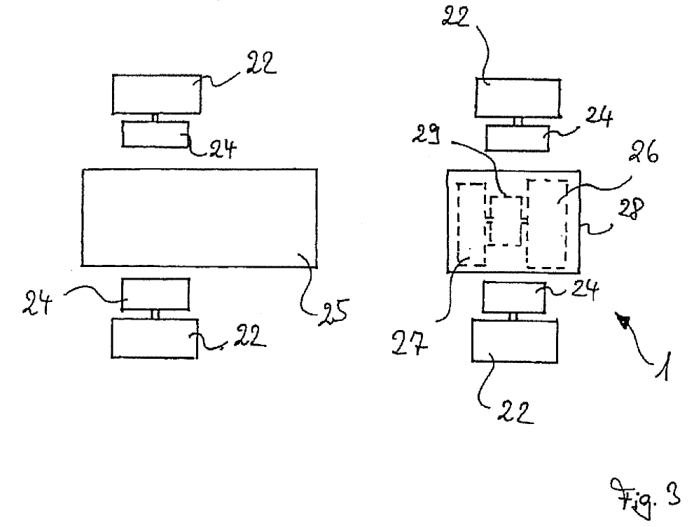

FIG. 3 shows another schematic view of an electric vehicle. In this configuration, there is a driving electric motor 23 on each wheel 22. Instead of driving each individual wheel 22 by an individual electric motor, only two wheels could be driven individually. A storage battery unit 25 is provided, for example, in the region of an axle, while a component consisting of a second generator 26 and a second Wankel engine 27 is arranged in a region of the other, opposite axle. The second generator 26 and the second Wankel engine 27 are advantageously arranged together, in turn, on a platform 28. Between the second generator 26 and the second Wankel engine 27 there can be, for example, at least one gearbox, one disk flywheel, one clutch, and/or one free-running hub. These are indicated with dashed lines as black box 29.

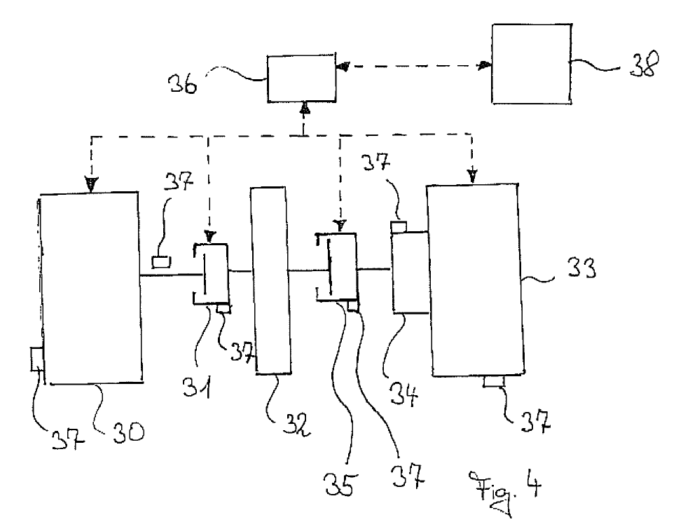

In an example configuration, FIG. 4 shows a possible arrangement of a third Wankel engine 30 that can be connected via a second clutch 31 to a flywheel 32. For example, the flywheel 32 can be driven by means of a third generator 33 and brought to a given rotational speed. The third Wankel engine 30 is coupled via the second clutch 31 to the flywheel 32 when the given rotational speed is reached and can therefore can be started. One improvement provides, for example, that for startup and/or for other operating states, the rotational speed can be increased or decreased. For this purpose, for example, a gearbox 34 is provided. This can be arranged, for example, on the third generator 33 but also at another location along a force-transmitting section between the third Wankel engine 30 and the third generator 33. It is also possible to realize a connection between the third generator 33 and the flywheel by means of a third clutch 35, for example, when the third Wankel engine 30 drives the flywheel 32 and the third generator 33 is coupled to it only at a later time or else is to be decoupled for continuous operation. There is also the possibility that during the operation of the third Wankel engine 30, flywheel 32, and third generator 33, the second and third clutch are each operated differently due to different operating states. Thus, the third generator 33 can also be used as a brake and a corresponding coupling or decoupling can be realized. An activation of a clutch is advantageously performed automatically. For example, for this purpose, a connection with a first control device 36 is provided that advantageously also simultaneously controls and/or regulates the third Wankel engine 30 and the third generator 33 in addition to a possibility of such automation. A connection to individual components of the system is drawn with dashed lines. This connection can involve bus systems, for example, a CAN bus or a system transmitting other data. In addition, one or more sensors 37 can also transmit their corresponding results in this way to the first control device 36. Sensors 37 can be arranged on each component of the system, in particular, on the third Wankel engine 30, on the third generator 33, but also on the corresponding clutches. They are shown, for example, as small boxes. The sensors 37 can record and transmit, advantageously, position, acceleration, temperature, oxygen concentration, time, velocity, rotation, angle, force, torque, electrical voltage, mechanical stress, electrical current, fluid flow information, and also other information. A link of the first control device 36 to another, second control device 38 is also possible, with the second control device 38 advantageously being a higher-level control device allocated to an electric vehicle. In this higher-level control device, the first control device 36 can be logged on and off, for example, during the installation or disassembly of the Wankel engine and generator.

It is claimed:

1. A drive mechanism of an electric vehicle that is driven only by means of one or more electric motors that are connected to at least one storage battery, wherein a generator is provided that can be connected for supplying energy to the drive mechanism, wherein the generator is coupled to a Wankel engine that drives only the generator when needed, but delivers no drive power as torque to a drive train of the electric motor or motors of the drive mechanism.

2. The drive mechanism according to claim 1, wherein the generator has a rotor shaft that is coupled to a driven shaft of the Wankel engine.

3. The drive mechanism according to claim 2, wherein a gearbox is arranged between the generator and the Wankel engine.

4. The drive mechanism according to claim 2, wherein a clutch is arranged between the generator and the Wankel engine.

5. The drive mechanism according to claim 1, wherein the generator can be driven by the drive train of the electric motor or motors for generating energy for at least one storage battery.

6. The drive mechanism according to claim 1, wherein a connection has a free-running hub between the generator and the Wankel engine.

7. The drive mechanism according to claim 1, wherein the generator and the Wankel engine are mounted on a common frame, wherein a housing of the Wankel engine, in alignment viewed laterally, does not project past a housing of the generator.

8. The drive mechanism according to claim 1, wherein an exhaust gas treatment device, mounted on a frame of the generator and Wankel engine, is provided for the Wankel engine.

9. The drive mechanism according claim 1, wherein a muffler for an exhaust gas train of the Wankel engine is arranged on a frame on which the generator and the Wankel engine are mounted.

10. The drive mechanism according claim 1, wherein a radiator, a fan, the Wankel engine, the generator, and then a muffler are arranged one after the other on a frame, wherein an exhaust gas post-treatment device is arranged underneath or at the side of the aforementioned assemblies on the frame.

11. The drive mechanism according to claim 1, wherein the generator and the Wankel engine are arranged on one end of the electric vehicle and one or more electric motors are arranged on an opposite end of the electric vehicle.

12. The drive mechanism according claim 1, wherein a fuel tank for the Wankel engine is arranged in its immediate vicinity.

13. The drive mechanism according to claim 1, wherein power monitoring for monitoring the operating state of the storage battery is provided, by means of which the Wankel engine can be activated.

14. The drive mechanism according to claim 1, wherein the generator can be connected for supplying energy to at least one of the storage batteries.

15. The drive mechanism according to claim 1, wherein the generator can be connected for supplying energy to at least one of the electric motors.

16. The drive mechanism according to claim 1, wherein a control unit for the generator and the Wankel engine is arranged on a frame on which the generator and the Wankel engine are also arranged and connected to each other.

17. The drive mechanism according to claim 1, wherein an air radiator with a fluid cooling circuit is arranged on a frame that holds the generator and the Wankel engine.

18. The drive mechanism according to claim 1, wherein a disk flywheel is allocated to the Wankel engine, wherein coupling and decoupling between the Wankel engine and the disk flywheel is provided.

19. The drive mechanism according to claim 1, wherein a disk flywheel allocated to the Wankel engine is arranged between the Wankel engine and the generator.

20. The drive mechanism according to claim 19, wherein the disk flywheel can be driven by the generator for transmitting torque to the Wankel engine.

21. A method for operating an electric vehicle that is driven only by means of one or more electric motors, wherein a storage battery operating state is monitored and a Wankel engine is activated when a given parameter is reached, wherein the Wankel engine drives only a generator in the electric vehicle, by means of which the electrical energy is generated that is used as a drive mechanism of the electric vehicle.

22. The method according to claim 21, wherein the electrical energy generated by the generator is fed directly to an electric motor.

23. The method according to claim 21, wherein the electrical energy generated by the generator is fed directly to a storage battery.

24. The method according to claim 21, wherein the Wankel engine is used for heating a passenger compartment of the electric vehicle.

25. The method according to claim 21, wherein the Wankel engine is used for heating at least one storage battery.

26. The method according to claim 21, wherein for starting the Wankel engine, the generator drives a flywheel and the Wankel engine is started by transmitting torque from the flywheel to the Wankel engine.

27. The method according to claim 26, wherein the Wankel engine is coupled to the flywheel for starting the Wankel engine.
